(19) United States
(12) Patent Application Publication
(10) Pub. No.: US 2021/0374777 A1
(43) Pub. Date: Dec. 2, 2021

(54) CUSTOMER LOYALTY DASHBOARD

(71) Applicant: STATE FARM MUTUAL AUTOMOBILE INSURANCE COMPANY, Bloomington, IL (US)

(72) Inventors: Michael James Schwerin, Bloomington, IL (US); David Albert Ritter, Bloomington, IL (US); Samuel Carl Karpen, Bloomington, IL (US); Jeffrey Allen Smith, North Pekin, IL (US); Joshua Thomas Rohlfs, Bloomington, IL (US); Andrew Lee Salmonson, Normal, IL (US)

(21) Appl. No.: 15/016,577

(22) Filed: Feb. 5, 2016

(51) Int. Cl. G06Q 30/02

(52) U.S. Cl. CPC G06Q 30/0203

(57) ABSTRACT

An instrument for measuring and presenting customer impressions of a vendor uses response values of survey questions to develop a consumer loyalty score, vendor attribute score, and/or a consumer experience score. The scores may be presented with other score sets for other vendors to provide a simple and consistent comparison of vendors. Vendor characteristics and/or categories are modeled to more accurately reflect the importance of specified characteristics and/or categories that affect consumer loyalty.

### TECHNICAL FIELD

This disclosure is directed to a system and method for evaluating customer loyalty, and more specifically, to compiling, weighting, and displaying a compilation of consumer business metrics, such as customer relationships involving one or more vendors.

### BACKGROUND

This Background is intended to provide the basic context of this patent application and it is not intended to describe a specific problem to be solved.

Evaluating customer loyalty to a business presents a number of challenges, including selection of what areas to query, what level of subjectivity to request of survey-participants, and selecting a weighting criteria that reflects the business impact of a particular topic. For a large business, where many business units contribute to the company's success, the customer loyalty measures may vary by business unit, further complicating the task of properly evaluating a customer experience with a vendor.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

To effectively evaluate customer loyalty to a vendor of a product or service, an evaluation tool recognizes several fundamental topics that affect consumer impressions or perceptions and constructs business-specific factors to measure each topic for that vendor, including across business lines. Any factor perceived as more important may be weighted for a particular vendor, business, or topic.

For many vendors, topics may include consumer perception of vendor attributes and customer interactions or experiences. Vendor attributes have a direct relationship with customer loyalty and include price and/or reputation. Customer experiences affect customer loyalty and include service quality, vendor availability, and vendor empathy. The impact of vendor attributes and/or customer experiences for products or services such as car insurance or life insurance may vary based on one or more topics, e.g., price, reputation, service quality, vendor availability, and/or vendor empathy. Developing questions along business lines for each topic allows for the collection of metrics for a common topic, e.g., service quality, which reflects a particular vendor's marketplace. Applying different weights when calculating scores provides a mechanism to adjust for the relative impact of a particular topic to customers of a particular vendor, business, or industry.

In one embodiment, a method of evaluating consumer loyalty to a vendor is executed on a computing device including one or more operatively coupled processors, one or more memory components, and a user interface including a display screen. The method comprises receiving, at the one or more processors, data including: i) a consumer perceived vendor attribute, wherein the consumer perceived vendor attribute includes a vendor attribute data associated with a price and/or a vendor reputation; ii) a consumer perceived customer experience with the vendor, wherein the consumer perceived customer experience with the vendor includes a customer experience data associated with a vendor service quality, a vendor availability, and/or a vendor empathy; and, iii) a consumer perceived customer loyalty, wherein the consumer perceived customer loyalty includes a customer loyalty data associated with a likelihood of a customer to remain a customer of the vendor, recommend the vendor, and/or intend to purchase additional services and/or goods from the vendor. The method further includes providing a data structure based on the vendor attribute data, the customer experience data, and the customer loyalty data, wherein the data structure describes an interrelationship among the consumer perceived vendor attribute, the consumer perceived customer experience with the vendor, and the consumer perceived customer loyalty. The method further includes adjusting the vendor attribute data and/or the consumer experience data of the data structure; calculating, by the one or more processors, a change to the interrelationship among the consumer perceived vendor attribute, the consumer perceived customer experience with the vendor, and the consumer perceived customer loyalty based on the adjusted vendor attribute data and/or the adjusted consumer experience data; rendering, by the one or more processors, an image including the calculated change to the interrelationship among the consumer perceived vendor attribute, the consumer perceived customer experience with the vendor, and the consumer perceived customer loyalty; and displaying, by the one or more processors, the image of the calculated change to the interrelationship among the consumer perceived vendor attribute, the consumer perceived customer experience with the vendor, and the consumer perceived customer loyalty via the user interface.

In another embodiment, a computer-readable storage media stores computer executable instructions for evaluating consumer loyalty to a vendor, wherein the instructions, when executed by one or more processors, cause the one or more processors to: receive data including: i) a consumer perceived vendor attribute, wherein the consumer perceived vendor attribute includes a vendor attribute data associated with a price and/or a vendor reputation; ii) a consumer perceived customer experience with the vendor, wherein the consumer perceived customer experience with the vendor includes a customer experience data associated with a vendor service quality, a vendor availability, and/or a vendor empathy; and, iii) a consumer perceived customer loyalty, the consumer perceived customer loyalty including a customer loyalty data associated with a likelihood of a customer to remain a customer of the vendor, recommend the vendor, and/or intend to purchase additional services and/or goods from the vendor. The executed instructions further provide a data structure based on the vendor attribute data, the customer experience data, and the customer loyalty data, wherein the data structure describes an interrelationship among the consumer perceived vendor attribute, the consumer perceived customer experience with the vendor, and the consumer perceived customer loyalty. The executed instructions further adjust the vendor attribute data and/or the consumer experience data of the data structure; calculate a change to the interrelationship among the consumer perceived vendor attribute, the consumer perceived customer experience with the vendor, and the consumer perceived customer loyalty based on the adjusted vendor attribute data and/or the adjusted consumer experience data. The executed instructions further render an image including the calculated change to the interrelationship among the consumer perceived vendor attribute, the consumer perceived customer experience with the vendor, and the consumer perceived customer loyalty; and display the image of the calculated change to the interrelationship among the consumer perceived vendor attribute, the consumer perceived customer experience with the vendor, and the consumer perceived customer loyalty via the user interface.

In a further embodiment, a system for evaluating consumer loyalty to a vendor comprises a server having one or more processors, a network interface for sending and receiving data via a network, and a computer storage media coupled to the one or more processors that stores computer executable instructions. The system further includes a plurality of computing devices coupled to the server via the network, wherein the computer executable instructions when executed by the processor cause the server to: receive data related to a customer loyalty including: i) a consumer perceived vendor attribute, wherein the consumer perceived vendor attribute includes a vendor attribute data associated with a price and/or a vendor reputation; ii) a consumer perceived customer experience with the vendor, wherein the consumer perceived customer experience with the vendor includes a customer experience data associated with a vendor service quality, a vendor availability, and/or a vendor empathy; and iii) a consumer perceived customer loyalty, wherein the consumer perceived customer loyalty includes a customer loyalty data associated with a likelihood of a customer to remain a customer of the vendor, recommend the vendor, and/or intend to purchase additional services and/or goods from the vendor. The executed instructions further provide a data structure based on the vendor attribute data, the customer experience data, and the customer loyalty data, wherein the data structure describes an interrelationship among the consumer perceived vendor attribute, the consumer perceived customer experience with the vendor, and the consumer perceived customer loyalty. The executed instructions further adjust the vendor attribute data and/or the consumer experience data of the data structure, and calculate a change to the interrelationship among the consumer perceived vendor attribute, the consumer perceived customer experience with the vendor, and the consumer perceived customer loyalty based on the adjusted vendor attribute data and/or the adjusted consumer experience data. The executed instructions further render an image including the calculated change to the interrelationship among the consumer perceived vendor attribute, the consumer perceived customer experience with the vendor, and the consumer perceived customer loyalty; and display the image of the calculated change to the interrelationship among the consumer perceived vendor attribute, the consumer perceived customer experience with the vendor, and the consumer perceived customer loyalty via the user interface.

The aspects and embodiments described herein utilize data including customer attitudes and perceptions, which may be captured through self-administered customer experience surveys, to provide an accurate estimate of customer loyalty to a vendor. More specifically, the technology described herein models characteristics and factor that contribute to changes in customer loyalty, thereby enabling a user to quickly identify and address changes in characteristics and/or factors affecting the loyalty relationship between a customer and a vendor.

It can readily be observed that the developed interrelationship among the consumer perceived vendor attribute, the consumer perceived customer experience with the vendor, and the consumer perceived customer loyalty can be utilized as a basis for numerous business applications, for example, identifying parameters for weighting within a structural equation model relating to vendor attribute data, consumer experience data, and/or customer loyalty; conducting predictive modeling related to determining effect sizes for changing vendor attributes and/or consumer experiences; creating simulation-based interface and characteristics for data-driven customer experience training programs and manuals; generating a behavior checklist for customer loyalty representative performance; developing marketing strategies targeted to strengths and/or weaknesses of business competitors; and coordinating consumer experience effect sizes to create a simulation-based interface for exploring implications of new underwriting and pricing plans.

### BRIEF DESCRIPTION OF THE DRAWINGS

FIG. 1 is a flow chart illustrating compilation and presentation of an exemplary customer loyalty dashboard;

FIG. 2 is a rendering of an exemplary customer loyalty dashboard;

FIGS. 3A-3C are illustrations of various structural equation models capable of being utilized to determine a correlation or interrelationship among consumer perceived vendor attribute, consumer perceived customer experience, and consumer perceived customer loyalty as described herein;

FIG. 4 is a flow chart illustrating a process for developing a customer loyalty dashboard; and

FIG. 5 is a simplified and exemplary block diagram of a system supporting processing and display of a customer loyalty dashboard.

### DETAILED DESCRIPTION OF THE INVENTION

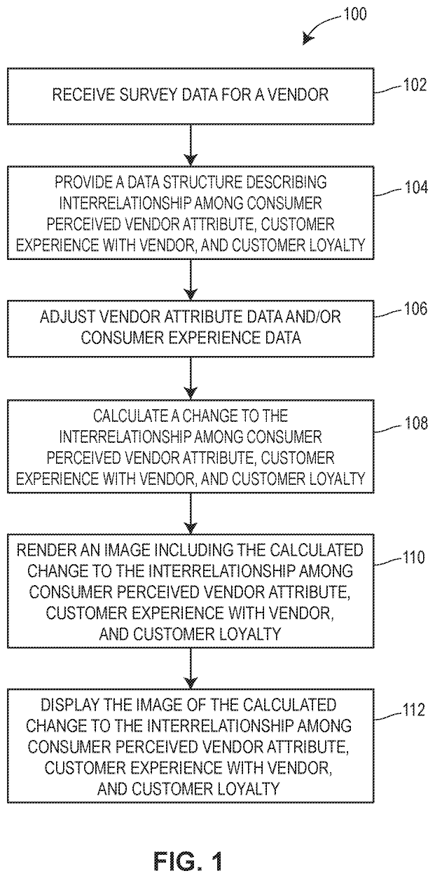

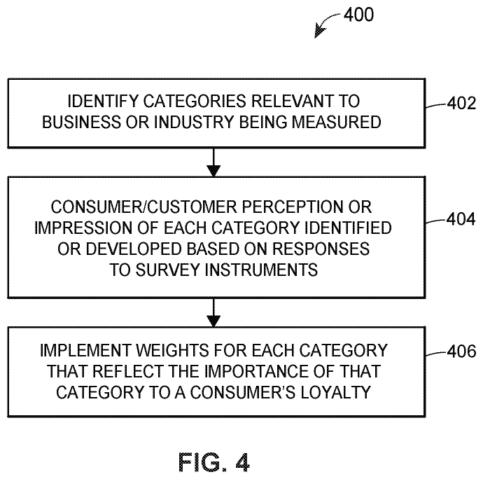

FIG. 1 is a flowchart of a method, routine, or process 100 for compilation and presentation of a customer loyalty dashboard. The method 100 may be performed on one or more computing devices, such as the computer system illustrated in FIG. 4. The system may receive data for a particular vendor, e.g., company (block 102). The data may be the result of a survey performed in person, over the telephone, or via the internet. The data may be in the form of responses to questions, where each question may contribute to an understanding of customer loyalty to a vendor, such as a consumer's perspective on a particular topic. Exemplary questions may be targeted to areas such as consumer perceived vendor attribute (e.g., price, reputation), consumer perceived customer experience (e.g., vendor service quality, vendor availability, vendor empathy), and/or consumer perceived customer loyalty (e.g., likelihood of a customer to remain a customer of the vendor, recommend the vendor, and/or intend to purchase additional services and/or goods from the vendor).

While the survey data may include information provided by consumers of a particular vendor, that is, persons purchasing a product or service from a company (e.g., an insurance or financial service company), other sources may provide information. For example, in an automobile insurance business, an individual involved in a car accident may interact with an insurance company other than her own during the course of getting her car repaired. For the purpose of this description, the terms customer and consumer are interchangeable and are assumed to include these “casual” or one-time business relationships.

After the data for a particular vendor is received, it may be broadly separated and utilized with a data structure for determining and/or describing an interrelationship among consumer perceived vendor attribute, consumer perceived customer experience with a vendor, and consumer perceived customer loyalty (104). For example, the broad subject areas may be classified as a vendor attribute, a customer experience, or customer loyalty, wherein each classification is intended to reflect different aspects of a customer's loyalty to the vendor.

In one embodiment, vendor attribute categories have a direct relationship with customer loyalty and may include, for example, price and reputation. Price relates to the actual price and/or value perceived by the customer for a service or good provided by the vendor. Reputation relates to a vendor trait, characteristic, and the like, perceived by the customer. Customer experience categories also have an effect on customer loyalty and may include, for example, vendor service quality (relates to vendor workmanship, etc., perceived and/or experienced by the customer), vendor availability (relates to vendor accessibility, responsiveness, etc., perceived and/or experienced by the customer), and vendor empathy (relates to personableness, caring, etc., perceived and/or experienced by the customer). The customer experience categories represent more or less subjective personal feelings about the customer's experience and may reflect specific instances when the customer interacted with the vendor and may include a purchase, quote, policy change, billing/payment, claim activity, etc. In some instances, one or more customer experience data may be combined into a single factor before being consolidated with other customer experience data and/or the vendor attribute data. Additionally, customer loyalty categories represent the likelihood of a customer to remain a customer of the vendor, recommend the vendor, and/or intend to purchase additional services and/or goods from the vendor.

The vendor attribute, customer experience, customer loyalty categories may have similar and/or dissimilar characteristics. Data acquired through survey questions may be applicable to one or more characteristics and/or to any of the vendor attribute, customer experience, customer loyalty categories. In general, any of these categories may include contributing factors to which questions may be directed during a survey process. For example, data gathered for any category based on a customer's impression of one or more of the following characteristics related to an interaction between the customer and the vendor involving a purchase, a quote, a policy change, a billing/payment, claim activity, etc.; and/or a customer experience with the vendor involving price (price compared to other vendors); satisfaction with price; responsiveness (responsive to questions or concerns); reliability (provides quality service, follow-up); brand (likelihood to be a customer in a year, likelihood to recommend, trustworthy, excellent reputation as a vendor); expertise (ability to answer customer questions); accuracy (does things right the first time, provides accurate information); availability (conducts business in a desired manner, and/or conducts business in a desired time); simplicity (easy to do business with, easy to understand explanations); caring (attentive and listens to customer concerns); respects, values, and/or appreciates customer); personalized (vendor knowledge of customer needs); etc.

The data structure may utilize structural equation modeling (SEM) to analytically determine the interrelationship among consumer perceived vendor attributes, customer experiences, and customer loyalty (block 108). In an example embodiment, algorithms may be utilized to model the factors described above that drive customer loyalty. For example, the data structure may incorporate algorithms to statistically model a customer and vendor relationship of the vendor attribute data to develop a vendor attribute score, a customer and vendor relationship of the experience data to develop a customer experience score, and a customer and vendor relationship of the customer loyalty data to develop a customer loyalty score. To reflect each factor's relative impact on customer loyalty, the survey data may be adjusted, combined, and/or weighted to a desired degree prior to, during, or after implementation of the structural equation modeling (block 106). Characteristics and/or factors of the various categories may be equally or unequally weighted to reflect the contribution of the characteristic and/or factor to customer loyalty.

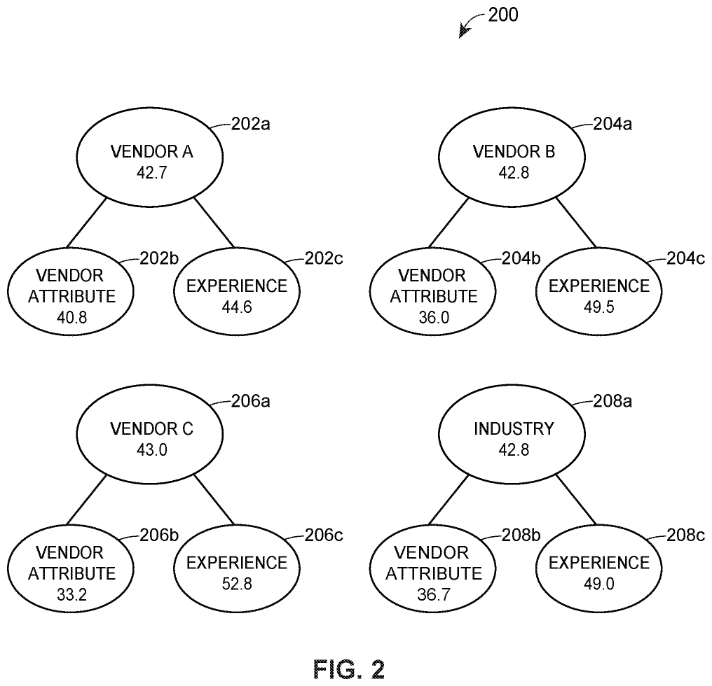

Images depicting the interrelationship among the consumer perceived vendor attribute, customer experience, and customer loyalty may be rendered (block 110) into a graphical form suitable for presentation, for example, via a web browser. When requested, the rendered image or images may be displayed (block 112 via a computer (i.e., a server, a laptop computer, an iPad or other tablet, a smart phone or any other computing device). For example, FIG. 2 illustrates a display of a rendered image of an exemplary customer loyalty dashboard 200, wherein the vendor attribute score and the consumer experience score are illustrated in separate shapes with a connector to the consumer loyalty score. When scores for a plurality of companies are available, a final metric may be developed as the average of consumer loyalty scores, vendor attribute scores, and consumer experience scores to reflect an industry or segment average. A single image with all vendors and industry scores may be rendered or each vendor may be rendered separately. The customer loyalty dashboard 200 may include vendor-specific customer loyalty scores 202a, 204a, and 206a. Each vendor-specific customer loyalty score may be illustrated with its respective component scores, in this example, vendor attribute scores 202b, 204b, and 206c and consumer experience scores 202c, 204c, and 206c. Also illustrated in FIG. 2 is an industry composite customer loyalty score 208a and its component vendor attribute score 208b and consumer experience score 208c. The industry score 208a, 208b, and 208c may be the average of the respective scores for the other three vendors, although more or fewer than three vendors may be represented in some industries or business segments. The customer loyalty dashboard 200 provides a single-look comparison between vendors and a summary breakdown of the major characteristics and factors contributing to the and overall scores. When used over time, the dashboard 140 provides a mechanism to track changes in customer sentiment and to evaluate the impact of customer-facing programs, such as changes to any of the characteristics described above that may affect customer loyalty.

While various structural equation models may be implemented to evaluate customer loyalty, important criteria that may be considered to determine the type of structural equation model utilized include strength of model fit and theoretical sensibility of factor and outcome relationship. One or more combinations of model fit indices known in structural equation modeling that may be utilized to determine customer loyalty include: chi-square test (χ²) for measuring how well the model recreates sample data, used for determining utility of modification indices, affected by sample size; root mean square error of approximation (RMSEA) for measuring model misfit and accounts for sample size; comparative fit index (CFI) for demonstrating the ratio of improvement of the specified mode over a null-model in which all variable are uncorrelated; and Tucker-Lewis Index (TLI) for measuring how accurate the specified model is to a perfectly fitting model.

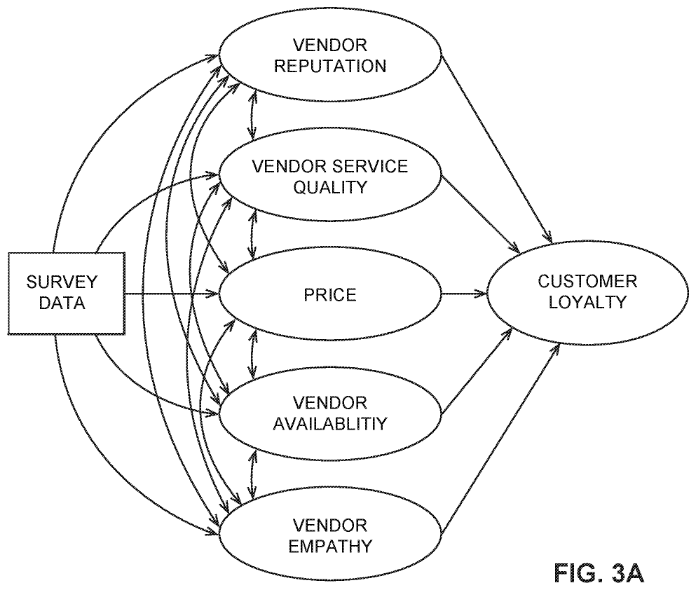

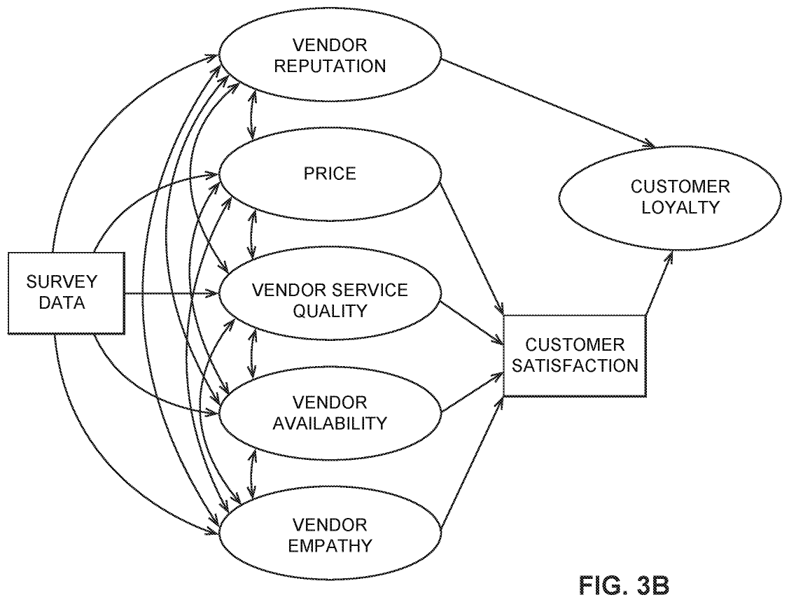

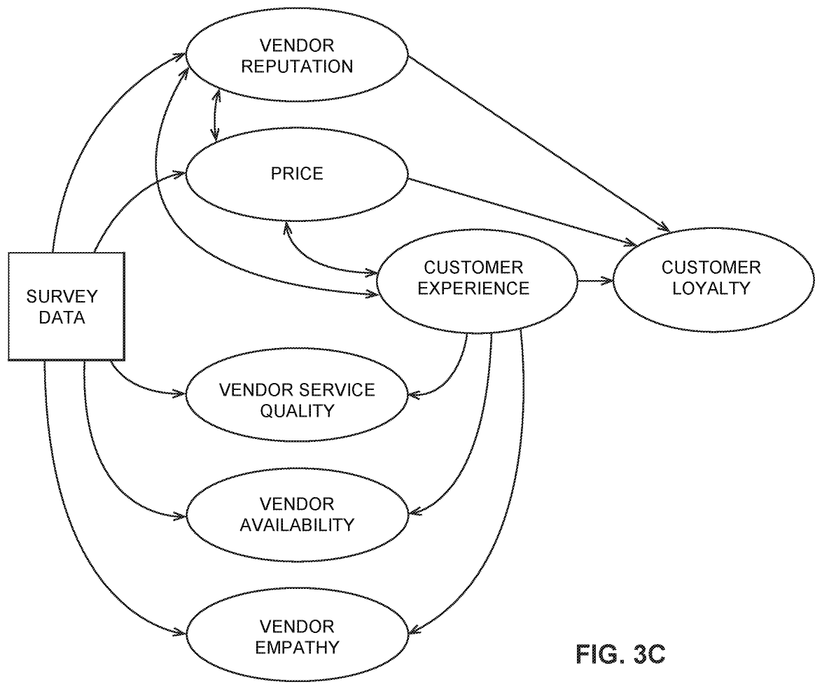

Various models that are effective for evaluating customer loyalty include: a direct model illustrated in FIG. 3A, wherein price, vendor reputation, vendor service quality, vendor availability and vendor empathy all have direct predictive relationships with customer loyalty; an indirect model illustrated in FIG. 3B, wherein price, vendor service quality, vendor availability, and vendor empathy predict overall satisfaction, and vendor reputation and overall satisfaction predict customer loyalty; and a 2^{nd}-order model illustrated in FIG. 3C, wherein vendor attribute (i.e., price and vendor reputation) and customer experience (i.e., vendor service quality, vendor availability, and vendor empathy) directly predict customer loyalty.

FIG. 4 is a flow chart illustrating a method, routine, or process 400 for developing a customer loyalty dashboard, such as the customer loyalty dashboard 200 of FIG. 2. The process 400 may involve identifying categories relevant to a business or industry that is to be measured (block 402). The consumer or customer perceptions or impressions may be identified or developed based on the responses to the various survey instruments (block 404). For example, to determine consumer perception of a vendor attributes and/or consumer experiences, a series of questions may be developed and directed to vendor responsiveness to consumer needs; pricing of goods and/or services; vendor empathy, etc. The development of this kind of instrument is a science of its own and is beyond the scope of the current disclosure. When the categories are defined, additional studies may be performed that evaluate how a particular category contributes to consumer perception of a vendor. Based on those studies, weighting factors for each category may be developed and applied during the generation of the customer loyalty dashboard (block 406), as discussed above.

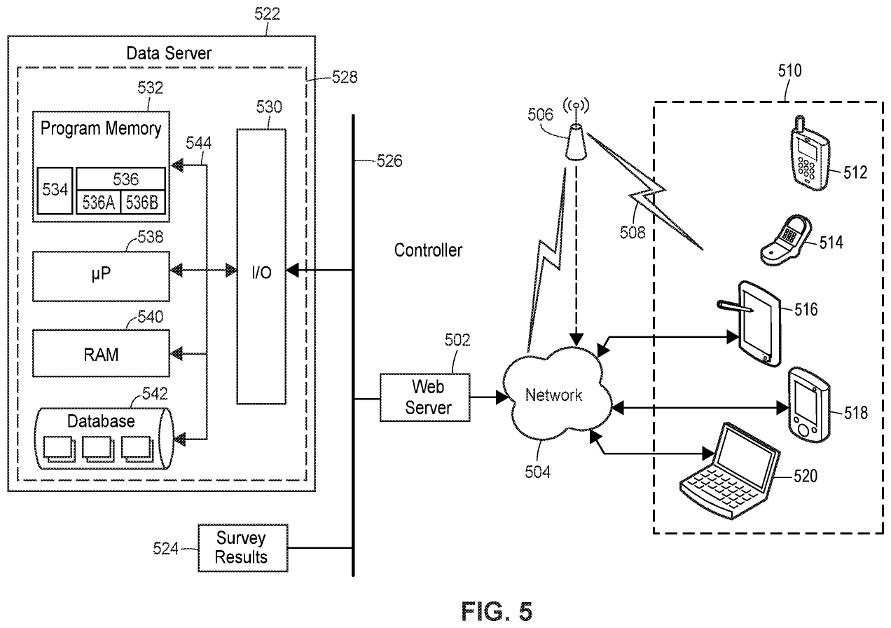

FIG. 5 illustrates various aspects of an exemplary architecture 500 implementing a customer satisfaction dashboard. The high-level architecture includes both hardware and software applications, as well as various data communications channels for communicating data between the various hardware and software components. In an embodiment, survey results 524 may be received from a third party survey company or an internal department responsible for customer and consumer research. The survey results storage 524 may be a part of a data server 522 or may be a separate server with independent memory.

In another embodiment, survey results may be received from a number of web-enabled devices 510 via a web server 502 connected over a network 504. These devices may include by way of example, a smart-phone 512, a web-enabled cell phone 514, a tablet computer 516, a personal digital assistant (PDA) 518, or a laptop/desktop computer 520. In some instances, the web enabled devices 510 may communicate with the network 504 via wireless signals 508 and, in some instances, may communicate with the network 504 via an intervening wireless or wired device 506, which may be a wireless router, a wireless repeater, a base transceiver station of a mobile telephony provider, etc. In most cases, the network 504 may be the Internet, using an Internet Protocol, but other networks may also be used.

The web server 502 may be implemented in one of several known configurations via one or more servers configured to process web-based traffic received via the network 504 and may include load balancing, edge caching, proxy services, authentication services, etc.

The data server 522 may be connected to the web server 502 via a network 526 and may implement the processes described above for compiling, weighting, and displaying the customer satisfaction dashboard.

The data server 522 includes a controller 528. The controller 528 includes a program memory 532, a microcontroller or a microprocessor (μP) 538, a random-access memory (RAM) 540, and an input/output (I/O) circuit 530, all of which are interconnected via an address/data bus 544. In some embodiments, the controller 528 may also include, or otherwise be communicatively connected to, a database 542 or other data storage mechanism (e.g., one or more hard disk drives, optical storage drives, solid state storage devices, etc.). The database 542 may include data such as customer questionnaires, if not implemented in the web server 502, etc. The database 542 may also include customer/consumer profile information for use in segmenting data, questions, categories, weighting by business and/or industry. It should be appreciated that although FIG. 5 depicts only one microprocessor 538, the controller 528 may include multiple microprocessors 538. Similarly, the memory 532 of the controller 528 may include multiple RAMs 534 and multiple program memories 536, 536A and 536B storing one or more corresponding server application modules, according to the controller's particular configuration. The data server 522 may also include specific routines, e.g., structural equation models, data structures, algorithms; to develop customer loyalty scores, vendor attribute scores, and/or customer experience scores, and to render the data into an image for display by a client computer (not depicted) or any of the web devices 510 via web server 502.

Although FIG. 5 depicts the I/O circuit 530 as a single block, the I/O circuit 530 may include a number of different types of I/O circuits (not depicted), including but not limited to, additional load balancing equipment, firewalls, etc. The RAM(s) 534, 540 and the program memories 536, 536A and 536B may be implemented in a known form of computer storage media, including but not limited to, semiconductor memories, magnetically readable memories, and/or optically readable memories, for example, but does not include transitory media such as carrier waves.

To the extent that any meaning or definition of a term in this document conflicts with any meaning or definition of the same term in a document incorporated by reference, the meaning or definition assigned to that term in this document shall govern. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “predicting,” “proposing,” determining,” “presenting,” “displaying,” “developing” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure (e.g., “means for” or “step for”), it is not intended that the scope of any claim element be interpreted based on the application of 35 U.S.C. § 112(f).

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. By way of example, and not limitation, the disclosure herein contemplates at least the following aspects:

Aspect 1: A method of evaluating consumer loyalty to a vendor, wherein the method is executed on a computing device including one or more operatively coupled processors, one or more memory components, and a user interface including a display screen. The method comprises receiving, at the one or more processors, data including: i) a consumer perceived vendor attribute, the consumer perceived vendor attribute including a vendor attribute data associated with a price and/or a vendor reputation; ii) a consumer perceived customer experience with the vendor, the consumer perceived customer experience with the vendor including a customer experience data associated with a vendor service quality, a vendor availability, and/or a vendor empathy; and, iii) a consumer perceived customer loyalty, the consumer perceived customer loyalty including a customer loyalty data associated with a likelihood of a customer to remain a customer of the vendor, recommend the vendor, and/or intend to purchase additional services and/or goods from the vendor. The method further includes providing a data structure based on the vendor attribute data, the customer experience data, and the customer loyalty data, wherein the data structure describes an interrelationship among the consumer perceived vendor attribute, the consumer perceived customer experience with the vendor, and the consumer perceived customer loyalty. The method further includes adjusting the vendor attribute data and/or the consumer experience data of the data structure; calculating, by the one or more processors, a change to the interrelationship among the consumer perceived vendor attribute, the consumer perceived customer experience with the vendor, and the consumer perceived customer loyalty based on the adjusted vendor attribute data and/or the consumer experience data; rendering, by the one or more processors, an image including the calculated change to the interrelationship among the consumer perceived vendor attribute, the consumer perceived customer experience with the vendor, and the consumer perceived customer loyalty; and displaying, by the one or more processors, the image of the calculated change to the interrelationship among the consumer perceived vendor attribute, the consumer perceived customer experience with the vendor, and the consumer perceived customer loyalty via the user interface.

Aspect 2: The method of aspect 1, wherein adjusting the vendor attribute data and/or the consumer experience data of the data includes weighting the vendor attribute data and/or the consumer experience data based on the customer loyalty data.

Aspect 3: The method of any one of aspects 1-2, further comprising a structure equation model for calculating a change to the interrelationship among the consumer perceived vendor attribute, the consumer perceived customer experience with the vendor, and the consumer perceived customer loyalty based on the adjusted vendor attribute data and/or the consumer experience data.

Aspect 4: The method of any one of aspects 1-3, further comprising determining a customer and vendor relationship of the vendor attribute data to develop a vendor attribute score.

Aspect 5: The method of any one of aspects 1-4, further comprising determining a customer and vendor relationship of the customer experience data to develop a customer experience score.

Aspect 6: The method of any one of aspects 1-5, further comprising determining a customer and vendor relationship of the customer loyalty data to develop a customer loyalty score.

Aspect 7: The method of any one of aspects 1-6, further comprising predictively modeling, by the one or more processors, the customer and vendor relationship of the vendor attribute data and the consumer experience data to develop an effect size for a change in the customer experience data.

Aspect 8: The method of any one of aspects 1-7, further comprising: organizing, by the one or more processors, the effect size into a consumer experience change catalog.

Aspect 9: The method of aspect 8, further comprising using, by the one or more processors, the consumer experience change catalog to create a consumer experience change catalog user-coach with a predictive model engine.

Aspect 10: The method of aspect 8, further comprising using, by the one or more processors, the consumer experience change catalog to create a simulation interface for a consumer experience training program.

Aspect 11: The method of aspect 8, further comprising using, by the one or more processors, the consumer experience change catalog to create a simulation interface for an underwriting or pricing plan.

Aspect 12: A computer-readable storage media storing computer executable instructions for evaluating consumer loyalty to a vendor, wherein the instructions when executed by one or more processors, cause the one or more processors to: receive data including: i) a consumer perceived vendor attribute, the consumer perceived vendor attribute including a vendor attribute data associated with a price and/or a vendor reputation; ii) a consumer perceived customer experience with the vendor, the consumer perceived customer experience with the vendor including a customer experience data associated with a vendor service quality, a vendor availability, and/or a vendor empathy; and, iii) a consumer perceived customer loyalty, the consumer perceived customer loyalty including a customer loyalty data associated with a likelihood of a customer to remain a customer of the vendor, recommend the vendor, and/or intend to purchase additional services and/or goods from the vendor. The executed instruction further provide a data structure based on the vendor attribute data, the customer experience data, and the customer loyalty data, the data structure describing an interrelationship among the consumer perceived vendor attribute, the consumer perceived customer experience with the vendor, and the consumer perceived customer loyalty. The executed instructions further adjust the vendor attribute data and/or the consumer experience data of the data structure; calculate a change to the interrelationship among the consumer perceived vendor attribute, the consumer perceived customer experience with the vendor, and the consumer perceived customer loyalty based on the adjusted vendor attribute data and/or the consumer experience data. The executed instructions further render an image including the calculated change to the interrelationship among the consumer perceived vendor attribute, the consumer perceived customer experience with the vendor, and the consumer perceived customer loyalty; and display the image of the calculated change to the interrelationship among the consumer perceived vendor attribute, the consumer perceived customer experience with the vendor, and the consumer perceived customer loyalty via the user interface.

Aspect 13: The computer-readable storage media of aspect 12, further comprising instructions that cause the one or more processors to weight the vendor attribute data and/or the consumer experience data based on the customer loyalty data.

Aspect 14: The computer-readable storage media of any one of aspects 12-13, further comprising instructions that cause the one or more processes to determine a customer and vendor relationship of the vendor attribute data to develop a vendor attribute score.

Aspect 15: The computer-readable storage media of any one of aspects 12-14, further comprising instructions that cause the one or more processes to determine a customer and vendor relationship of the customer experience data to develop a customer experience score.

Aspect 16: The computer-readable storage media of any one of aspects 12-15, further comprising instructions that cause the one or more processes to determine a customer and vendor relationship of the customer loyalty data to develop a customer loyalty score.

Aspect 17: The computer-readable storage media of any one of aspects 12-16, further comprising instructions that cause the one or more processes to predictively model the customer and vendor relationship of the vendor attribute data and the consumer experience data to develop an effect size for a change in the customer experience data.

Aspect 18: The computer-readable storage media of aspect 17, further comprising instructions that cause the one or more processes to organize the effect size into a consumer experience change catalog.

Aspect 19: The computer-readable storage media of aspect 18, further comprising instructions that cause the one or more processes to determine use the consumer experience change catalog to create a consumer experience change catalog user-coach with a predictive model engine.

Aspect 20: The computer-readable storage media of aspect 18, further comprising instructions that cause the one or more processes to use the consumer experience change catalog to create a simulation interface for a consumer experience training program and/or an underwriting or pricing plan

Aspect 21: A system for evaluating consumer loyalty to a vendor comprising a server having one or more processors, a network interface for sending and receiving data via a network, and a computer storage media coupled to the one or more processors that stores computer executable instructions. The system further includes a plurality of computing devices coupled to the server via the network, wherein the computer executable instructions when executed by the processor cause the server to: receive data related to a customer loyalty including: i) a consumer perceived vendor attribute, the consumer perceived vendor attribute including a vendor attribute data associated with a price and/or a vendor reputation; ii) a consumer perceived customer experience with the vendor, the consumer perceived customer experience with the vendor including a customer experience data associated with a vendor service quality, a vendor availability, and/or a vendor empathy; and iii) a consumer perceived customer loyalty, the consumer perceived customer loyalty including a customer loyalty data associated with a likelihood of a customer to remain a customer of the vendor, recommend the vendor, and/or intend to purchase additional services and/or goods from the vendor. The executed instructions further provide a data structure based on the vendor attribute data, the customer experience data, and the customer loyalty data, wherein the data structure describes an interrelationship among the consumer perceived vendor attribute, the consumer perceived customer experience with the vendor, and the consumer perceived customer loyalty. The executed instructions further adjust the vendor attribute data and/or the consumer experience data of the data structure, and calculate a change to the interrelationship among the consumer perceived vendor attribute, the consumer perceived customer experience with the vendor, and the consumer perceived customer loyalty based on the adjusted vendor attribute data and/or the consumer experience data. The executed instructions further render an image including the calculated change to the interrelationship among the consumer perceived vendor attribute, the consumer perceived customer experience with the vendor, and the consumer perceived customer loyalty; and display the image of the calculated change to the interrelationship among the consumer perceived vendor attribute, the consumer perceived customer experience with the vendor, and the consumer perceived customer loyalty via the user interface.

1. A method of evaluating consumer loyalty to a vendor across vendor business lines, the method executed on a computing device including an operatively coupled one or more processors, a memory, and a user interface including a display screen, the method comprising:
receiving, at the one or more processors, data including:
i) a consumer perceived vendor attribute across vendor business lines, the consumer perceived vendor attribute including a vendor attribute data associated with a price and/or a vendor reputation across the vendor business lines;
ii) a consumer perceived customer experience with the vendor across the vendor business lines, the consumer perceived customer experience with the vendor including a customer experience data associated with a vendor service quality, a vendor availability, and/or a vendor empathy across the vendor business lines;
iii) a consumer perceived customer loyalty across the vendor business lines, the consumer perceived customer loyalty including a customer loyalty data associated with the following: a likelihood of a customer to recommend the vendor across the vendor business lines, remain a customer of the vendor, and intend to purchase additional services and/or goods from the vendor across the vendor business lines;
providing a data structure based on the vendor attribute data, the customer experience data, and the customer loyalty data, the data structure describing an interrelationship among the consumer perceived vendor attribute, the consumer perceived customer experience with the vendor, and the consumer perceived customer loyalty;
adjusting the vendor attribute data and/or the consumer experience data of the data structure;
calculating, by the one or more processors, a change to the interrelationship among the consumer perceived vendor attribute, the consumer perceived customer experience with the vendor, and the consumer perceived customer loyalty based on the adjusted vendor attribute data and the consumer experience data;
rendering, by the one or more processors, an image including the calculated change to the interrelationship among the consumer perceived vendor attribute, the consumer perceived customer experience with the vendor, and the consumer perceived customer loyalty; and
displaying, by the one or more processors, the image of the calculated change to the interrelationship among the consumer perceived vendor attribute, the consumer perceived customer experience with the vendor, and the consumer perceived customer loyalty via the user interface.

2. The method of claim 1, wherein adjusting the vendor attribute data and/or the consumer experience data of the data includes weighting the vendor attribute data and/or the consumer experience data based on the customer loyalty data.

3. The method of claim 1, further comprising a structure equation model for calculating a change to the interrelationship among the consumer perceived vendor attribute, the consumer perceived customer experience with the vendor, and the consumer perceived customer loyalty based on the adjusted vendor attribute data and/or the consumer experience data.

4. The method of claim 1, further comprising determining a customer and vendor relationship of the vendor attribute data to develop a vendor attribute score.

5. The method of claim 1, further comprising determining a customer and vendor relationship of the customer experience data to develop a customer experience score.

6. The method of claim 1, further comprising determining a customer and vendor relationship of the customer loyalty data to develop a customer loyalty score.

7. The method of claim 1, further comprising:
predictively modeling, by the one or more processors, the customer and vendor relationship of the vendor attribute data and the consumer experience data to develop an effect size for a change in the customer experience data.

8. The method of claim 7, further comprising:
organizing, by the one or more processors, the effect size into a consumer experience change catalog.

9. The method of claim 8, further comprising:
using, by the one or more processors, the consumer experience change catalog to create a consumer experience change catalog user-coach with a predictive model engine.

10. The method of claim 8, further comprising:
using, by the one or more processors, the consumer experience change catalog to create a simulation interface for a consumer experience training program.

11. The method of claim 8, further comprising:
using, by the one or more processors, the consumer experience change catalog to create a simulation interface for an underwriting or pricing plan.

12. A computer-readable storage media storing computer executable instructions for evaluating consumer loyalty to a vendor across vendor business lines, wherein the instructions when executed by one or more processors, cause the one or more processors to:
receive, at the one or more processors, data including:
i) a consumer perceived vendor attribute across vendor business lines, the consumer perceived vendor attribute including a vendor attribute data associated with a price and/or a vendor reputation across the vendor business lines;
ii) a consumer perceived customer experience with the vendor across the vendor business lines, the consumer perceived customer experience with the vendor including a customer experience data associated with a vendor service quality, a vendor availability, and/or a vendor empathy across the vendor business lines;
iii) a consumer perceived customer loyalty across the vendor business lines, the consumer perceived customer loyalty including a customer loyalty data associated with the following: a likelihood of a customer to recommend the vendor across the vendor business lines, remain a customer of the vendor, and intend to purchase additional services and/or goods from the vendor across the vendor business lines;
provide a data structure based on the vendor attribute data, the customer experience data, and the customer loyalty data, the data structure describing an interrelationship among the consumer perceived vendor attribute, the consumer perceived customer experience with the vendor, and the consumer perceived customer loyalty;
adjust the vendor attribute data and/or the consumer experience data of the data structure;
calculate a change to the interrelationship among the consumer perceived vendor attribute, the consumer perceived customer experience with the vendor, and the consumer perceived customer loyalty based on the adjusted vendor attribute data and the consumer experience data;
render an image including the calculated change to the interrelationship among the consumer perceived vendor attribute, the consumer perceived customer experience with the vendor, and the consumer perceived customer loyalty; and
display the image of the calculated change to the interrelationship among the consumer perceived vendor attribute, the consumer perceived customer experience with the vendor, and the consumer perceived customer loyalty via the user interface.

13. The computer-readable storage media of claim 12, further comprising instructions that cause the one or more processors to weight the vendor attribute data and/or the consumer experience data based on the customer loyalty data.

14. The computer-readable storage media of claim 12, further comprising instructions that cause the one or more processes to determine a customer and vendor relationship of the vendor attribute data to develop a vendor attribute score.

15. The computer-readable storage media of claim 12, further comprising instructions that cause the one or more processes to determine a customer and vendor relationship of the customer experience data to develop a customer experience score.

16. The computer-readable storage media of claim 12, further comprising instructions that cause the one or more processes to determine a customer and vendor relationship of the customer loyalty data to develop a customer loyalty score.

17. The computer-readable storage media of claim 12, further comprising instructions that cause the one or more processes to predictively model the customer and vendor relationship of the vendor attribute data and the consumer experience data to develop an effect size for a change in the customer experience data.

18. The computer-readable storage media of claim 17, further comprising instructions that cause the one or more processes to organize the effect size into a consumer experience change catalog.

19. The computer-readable storage media of claim 12, further comprising instructions that cause the one or more processes to determine use the consumer experience change catalog to create a consumer experience change catalog user-coach with a predictive model engine.

20. The computer-readable storage media of claim 12, further comprising instructions that cause the one or more processes to use the consumer experience change catalog to create a simulation interface for a consumer experience training program and/or an underwriting or pricing plan.

21. A system for evaluating consumer loyalty to a vendor across vendor business lines, the system comprising:
a server having one or more processors, a network interface for sending and receiving data via a network, and a computer storage media coupled to the one or more processors that stores computer executable instructions;
a plurality of computing devices coupled to the server via the network, wherein the computer executable instructions when executed by the processor cause the server to:
receive data related to a customer loyalty including:
i) a consumer perceived vendor attribute across vendor business lines, the consumer perceived vendor attribute including a vendor attribute data associated with a price and/or a vendor reputation across the vendor business lines;
ii) a consumer perceived customer experience with the vendor across the vendor business lines, the consumer perceived customer experience with the vendor including a customer experience data associated with a vendor service quality, a vendor availability, and/or a vendor empathy across the vendor business lines;
iii) a consumer perceived customer loyalty across the vendor business lines, the consumer perceived customer loyalty including a customer loyalty data associated with the following: a likelihood of a customer to recommend the vendor across the vendor business lines, remain a customer of the vendor, and intend to purchase additional services and/or goods from the vendor across the vendor business lines;
provide a data structure based on the vendor attribute data, the customer experience data, and the customer loyalty data, the data structure describing an interrelationship among the consumer perceived vendor attribute, the consumer perceived customer experience with the vendor, and the consumer perceived customer loyalty;
adjust the vendor attribute data and/or the consumer experience data of the data structure;
calculate a change to the interrelationship among the consumer perceived vendor attribute, the consumer perceived customer experience with the vendor, and the consumer perceived customer loyalty based on the adjusted vendor attribute data and/or the consumer experience data;
render an image including the calculated change to the interrelationship among the consumer perceived vendor attribute, the consumer perceived customer experience with the vendor, and the consumer perceived customer loyalty; and display the image of the calculated change to the interrelationship among the consumer perceived vendor attribute, the consumer perceived customer experience with the vendor, and the consumer perceived customer loyalty via the user interface.
